(19) United States
(12) Patent Application Publication
(10) Pub. No.: US 2018/0237289 A1
(43) Pub. Date: Aug. 23, 2018

(54) TIME PRESSURE DOSING FUEL ADDITIVE DELIVERY SYSTEM

(71) Applicant: Additech, Inc., Houston, TX (US)

(72) Inventor: Aaron Lynn Markwardt, League City, TX (US)

(21) Appl. No.: 15/753,063

(22) PCT Filed: Sep. 2, 2016
(86) PCT No.: PCT/US16/50143

§ 371 Date: Feb. 15, 2018

Related U.S. Application Data
(60) Provisional application No. 62/213,770, filed on Sep. 3, 2015.

(51) Int. Cl. B67D 7/36; B67D 7/62; B67D 7/74; B67D 7/78; G05D 11/13

(52) U.S. Cl. CPC B67D 7/36; B67D 7/62; B67D 2007/748; B67D 7/78; G05D 11/13; B67D 7/744

(57) ABSTRACT

Systems and methods are provided for delivering, and controlling the delivery of, one or more fuel additives to one or more fuel hoses at a fuel dispenser. The system comprises a plurality of additive storage tanks, each containing a fuel additive, and a plurality of additive lines for delivering a different fuel additives to the fuel dispenser; a pump coupled for drawing a corresponding additive into and pressurizing the additive line, and a pressure transducer coupled for measuring a pressure generated within the additive line. The plurality of additive lines terminate into one or more output manifolds arranged at the fuel dispenser, wherein each output manifold comprises a plurality of solenoid valves, each coupled to a different additive line. An additive delivery controller is included within the system and coupled to each pump, pressure transducer and solenoid for controlling the delivery of the fuel additives to the fuel hoses.

This application claims priority to the following provisional application: U.S. Patent Application Ser. No. 62/213,770, filed Sep. 3, 2015, and entitled “TIME PRESSURE DOSING FUEL ADDITIVE DELIVERY SYSTEM,” which is hereby incorporated by reference in its entirety.

### BACKGROUND OF THE INVENTION

### 1. Field of the Invention

The present invention relates to fuel dispensing systems, and more particularly, for additive delivery systems configured for adding one or more fuel additives into one or more fuel streams at a fuel dispenser.

### 2. Description of the Related Art

The following descriptions and examples are provided as background only and are intended to reveal information that is believed to be of possible relevance to the present invention. No admission is necessarily intended, or should be construed, that any of the following information constitutes prior art impacting the patentable character of the subject matter claimed herein.

Fuel additives are well known in the art. Fuel additives are typically petroleum-based or synthetic chemical products that can be formulated to address specific driving or automotive performance issues when added to gasoline or diesel fuels. For examples, additives may be added to clean fuel system components, enhance overall engine performance, improve fuel economy, reduce emissions and prevent freezing of fuel lines in cold weather conditions.

Historically, additives have been blended into the fuel at various stages. For example, additives needed in all gasolines are added at the refinery. In addition to those additives, major oil companies often blend proprietary additives into their gasoline (e.g., Chevron Techron® and Shell Vpower®) and promote such additives to encourage brand allegiance. These proprietary additives are typically added at the bulk terminal, e.g., by adding the proprietary additives when the fuel is loaded into transport trucks for delivery to service stations.

However, pre-blending additives at the refinery or bulk terminal is not always ideal. Some additives are volatile and some begin to degrade once mixed with fuel. In addition, the treat rate (or concentration levels) for many pre-blended additives is often low and may not provide much added benefit, as the treat rate is primarily intended to enable the blended fuel to meet minimum EPA regulatory requirements. Furthermore, pre-blending additives into the fuel at the refinery or bulk terminal does not allow a motorist to customize or select particular additives he/she would like to add to his/her fuel tank. While a market has developed for bottled after-market additives, which enable a motorist to select particular additives and enable treat rates many times that of pre-blended additives (thereby greatly enhancing cleaning, performance and other benefits), the purchase and use of bottled after-market additives can be inconvenient, messy and cumbersome. Therefore, it is generally desirable to selectively blend additives into fuels at the fuel dispenser when a customer is refueling his/her automobile.

Various systems and methods have been disclosed in the prior art to facilitate blending of additives into fuels at fuel dispensers. For example, U.S. Pat. No. 5,018,645 and U.S. Pat. No. 5,163,586 to Zinsmeyer propose fuel dispensers with additive dispensing capabilities in which additives may be dispensed along with fuel. However, the fuel dispensers described in these prior art patents do not allow a given additive to be simultaneously dispensed into separate fuel streams directed to separate fuel hoses, as might occur when two different customers refueling at the same time select the same additive. A need therefore exists for a fuel dispenser and/or additive delivery system with additive dispensing capabilities that overcomes this and other disadvantages found in the prior art.

### SUMMARY OF THE INVENTION

The following description of various embodiments of systems and methods for blending additives into fuel at a fuel dispenser is not to be construed in any way as limiting the subject matter of the appended claims.

According to one embodiment, a system is provided herein for delivering, and controlling the delivery of, one or more fuel additives to one or more fuel hoses at a fuel dispenser. In general, the system may comprise a plurality of additive storage tanks, each containing a fuel additive, and a plurality of additive lines, each coupled to a different one of the additive storage tanks for delivering a different one of the fuel additives to the fuel dispenser. For each fuel hose at the fuel dispenser, the system may further comprise a pressure transducer, which is coupled for measuring a fuel pressure generated within the fuel hose.

For each additive line included within the system, the system may further comprise a pump coupled to the additive line for drawing a corresponding fuel additive into and pressurizing the additive line, and a pressure transducer coupled for measuring an additive pressure generated within the additive line. The plurality of additive lines may terminate into one or more output manifolds arranged at the fuel dispenser. Each output manifold is coupled to a different one of the one or more fuel hoses, and each output manifold comprises a plurality of solenoid valves, each coupled to a different additive line.

In the system described herein, a separate pump, a separate pressure transducer and a separate solenoid valve is coupled to each separate additive line for respectively drawing the fuel additive into and pressurizing the separate additive line, measuring an additive pressure generated within the separate additive line and delivering the fuel additive to a fuel hose. Stated another way, the plurality of additive storage tanks do not share additive lines, pumps, pressure transducers or solenoid valves. This enables the system described herein to increase the accuracy of the fuel additive delivery and avoid cross-contamination between different fuel additives contained within different additive storage tanks.

An additive delivery controller is also included within the system and coupled to each pump, each pressure transducer and each solenoid for controlling the delivery of one or more fuel additives to one or more fuel hoses. Upon receiving notice of a customers' selection of one or more fuel additives, the additive delivery controller activates the corresponding additive pump(s) to draw the additive(s) into and pressurize the additive line(s). The additive delivery controller then measures the fuel pressure delivered to the fuel hose(s) and the additive pressure within the additive line(s), and calculates a pressure differential between the fuel pressure and the additive pressure for each fuel hose.

According to one embodiment, the additive delivery controller may use the calculated pressure differentials to determine how long each solenoid valve must be held open (referred to herein as a “solenoid open time”) to deliver target volume(s) of additive to each fuel hose/customer requesting such additive. Once a solenoid open time is determined for a particular solenoid valve, the solenoid valve may be opened for the duration of solenoid open time and then closed.

According to another embodiment, the additive delivery controller may determine the pressure differential periodically at discrete intervals of time after a solenoid valve is opened to deliver a fuel additive to a fuel hose. In such an embodiment, the additive delivery controller may use each periodically determined pressure differential to determine an incremental additive volume delivered during each discrete interval of time, accumulate the incremental additive volumes over the discrete intervals of time, and close the solenoid valve when the accumulated additive volume reaches a target volume of delivered additive.

### BRIEF DESCRIPTION OF THE DRAWINGS

Other objects and advantages of the invention will become apparent upon reading the following detailed description and upon reference to the accompanying drawings in which:

FIG. 1 is a block diagram of a prior art fuel dispenser with additive dispensing capabilities;

FIG. 2 is a block diagram of a fuel dispenser having or coupled to a fuel additive dispensing unit with improved additive dispensing capabilities, according to one embodiment of the invention;

FIG. 3 is a flowchart diagram illustrating one embodiment of a method for controlling the amount of additive to be added to a given fuel stream by using a measured pressure differential to determine an amount of time that a valve should be held open to deliver a target volume of additive;

FIG. 4 is a graph illustrating one manner for determining the amount of time that the valve should be held open to deliver the target volume of additive in the method shown in FIG. 3;

FIG. 5 is a graph illustrating another manner for determining the amount of time that the valve should be held open to deliver the amount of additive in the method shown in FIG. 3;

FIG. 6 is a flowchart diagram illustrating another embodiment of a method for controlling the amount of additive to be added to a given fuel stream by using a measured pressure differential to determine a cumulative amount of additive delivered over time, until the cumulative amount of delivered additive reaches a target volume of additive; and

FIG. 7 is a block diagram of a fuel dispenser having, or coupled to, a fuel additive dispensing unit with improved additive dispensing capabilities, according to another embodiment of the invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF PREFERRED EMBODIMENTS

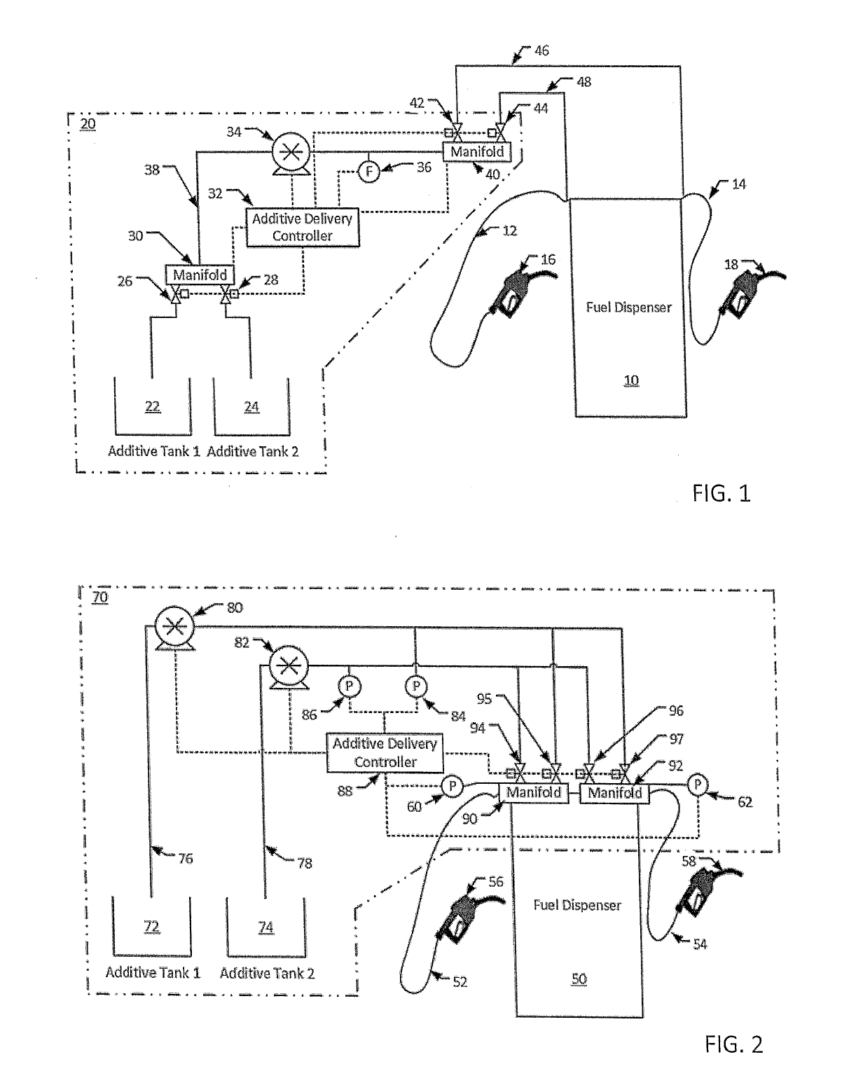

Turning now to the drawings, FIG. 1 shows a prior art fuel dispenser 10 incorporating a fuel additive dispensing unit 20. The additive dispensing unit 20 may be physically separated from, directly attached to, or incorporated within the fuel dispenser 10. The fuel dispenser 10 may have a plurality of fuel hoses 12, 14, each with a nozzle 16, 18 for dispensing fuel into a fuel tank or other appropriate container. Although not shown in FIG. 1, fuel dispenser 10 may also include nozzle lift indicators for monitoring the initiation and termination of fueling transactions with a given fuel hose, and fuel flow meters for monitoring the fuel flow rates attributed to each fuel stream.

The fuel additive dispensing unit 20 shown in FIG. 1 generally comprises a plurality of additive storage tanks 22, 24 (e.g., additive tank 1 and additive tank 2), each containing a different fuel additive, an input manifold 30, an additive pump 34, an additive flow meter 36, an output manifold 40 and a number of shared additive lines 38, 46 and 48. The fuel additives stored within the additive storage tanks 22, 24 may generally include, but are not limited to, additives formulated for cleaning fuel system components, enhancing overall engine performance, improving fuel economy, reducing emissions and preventing freezing of fuel lines in cold weather conditions.

The input manifold 30 comprises one solenoid valve (e.g., 26, 28) for each additive storage tank 22, 24, while the output manifold 40 comprises one solenoid valve (e.g., 42, 44) for each fuel hose 12, 14 included at the fuel dispenser 10. The solenoid valves (e.g., 26, 28, 42, and 44) are normally-closed valves, which may be opened under the control of an additive delivery controller 32 for adding one or more of the additives from storage tanks 22, 24 sequentially into a particular fuel stream directed to one of the fuel hoses 12 or 14.

The fuel additives available for purchase may be selected by a customer at the fuel dispenser 10, or alternatively, at the additive dispensing unit 20. Upon receiving notice of a customer's selection of one or more additives, the additive delivery controller 32 opens one solenoid valve (26 or 28) on the input manifold 30 corresponding to a first additive, operates the additive pump 34 to draw the first additive into and pressurize the shared additive line 38, and begins monitoring the flow rate of the fuel stream (via electronic signals from a corresponding fuel flow meter). When the additive delivery controller 32 detects that fuel has begun to flow (via the fuel flow meter), the additive delivery controller 32 opens one solenoid valve (42 or 44) on the output manifold 40 to deliver the first additive to the appropriate fuel hose (12 or 14) via one of the shared additive lines (46 or 48). The additive delivery controller 32 monitors the delivered volume of the first additive (via electronic signals from additive flow meter 36) and closes the solenoid valve (42 or 44) on the output manifold 40 once the correct amount of additive has been delivered. If more than one fuel additive is selected by the customer, the selected fuel additives are added to the fuel stream sequentially (i.e., one at a time).

The fuel additive dispensing unit 20 shown in FIG. 1 has several limitations. As noted above, the fuel additive dispensing unit 20 uses shared additive lines 38, 46 and 48 for directing multiple types of fuel additives to multiple fuel hoses 12, 14. When multiple additives are selected by a customer, the additives must be added one at a time to the fuel stream, due to the shared additive lines 38, 46 and 48. Another problem with the fuel additive dispensing unit 20 is that it has no mechanism for flushing the shared additive lines 38 and 46/48 when switching between different additives to avoid contamination within the lines. In addition to cross-contamination of delivered products, the sequential delivery of two different additive products will increase the delivered volume of the first additive product and reduce the accuracy of the second additive product delivery, as the residual first additive product must be pumped into the fuel line before delivery of the second additive product can begin. The shared additive lines 38, 46 and 48 also do not allow different additives to be simultaneously directed to different fuel hoses 12, 14, as might occur when two different customers refueling at the same time select different additive products. Finally, control and accuracy of the fuel additive dispensing unit 20 is limited to about 0.5 mL/delivery by arranging the output solenoids (42, 44) away from the fuel hoses (12, 14).

A fuel dispenser 50 comprising or coupled to an improved fuel additive dispensing unit 70 is shown in FIG. 2. Similar to the embodiment shown in FIG. 1, the improved additive dispensing unit 70 may be physically separated from, directly attached to, or incorporated within the fuel dispenser 50. The fuel dispenser 50 may have a plurality of fuel hoses 52, 54, each with a nozzle 56, 58 for dispensing fuel into a fuel tank or other appropriate container, and fuel pressure transducer 60, 62 for monitoring the fuel pressure attributed to each fuel stream. Although not shown in FIG. 2, fuel dispenser 50 may also include nozzle lift indicators for monitoring the initiation and termination of fueling transactions with a given fuel hose.

The improved fuel additive dispensing unit 70 shown in FIG. 2 comprises a plurality of additive storage tanks 72, 74, each containing a fuel additive. Although only two storage tanks (e.g., additive tank 1 and additive tank 2) are shown in FIG. 2, it is generally understood that any number of storage tanks may be included without departing from the scope of the invention. In some embodiments, the plurality of additive storage tanks may each contain a different fuel additive. In other embodiments, two or more of the additive storage tanks may contain the same fuel additive. The fuel additives stored within the additive storage tanks 72, 74 may generally include, but are not limited to, additives formulated for cleaning fuel system components, enhancing overall engine performance, improving fuel economy, reducing emissions and preventing freezing of fuel lines in cold weather conditions.

A primary difference between the fuel additive dispensing units shown in FIGS. 1 and 2 is that the improved fuel additive dispensing unit 70 does not share additive lines or meters, and instead, comprises a separate additive line 76, 78 for each additive storage tank 72, 74 and a separate pressure transducer 84, 86 for monitoring the pressure generated within each line. A separate pump 80, 82 is also provided for each additive line 76, 78 for drawing each additive into and pressurizing each additive line.

As shown in FIG. 2, each additive line 76, 78 terminates in a separate output manifold 90, 92, which is arranged at the fuel dispenser 50. Each output manifold 90, 92 is coupled to a different fuel hose (52 or 54) and comprises one solenoid valve (e.g., 94, 95 or 96, 97) for each additive line 76, 78. The solenoid valves (e.g., 94, 95, 96, 97) are normally-closed valves, which are opened under the control of an additive delivery controller 88 for simultaneously adding one or more of the additives from storage tanks 72, 74 into one or more of the fuel streams directed to one or more of the fuel hoses 52 or 54.

The fuel additives available for purchase may be selected by a customer at the fuel dispenser 50, or alternatively, at the fuel additive dispensing unit 70. Upon receiving notice of a customer's selection of one or more additives, the additive delivery controller 88 opens one or more solenoid valves on the output manifold (90 or 92) corresponding to the fuel hose (52 or 54) in use. If two customers refueling at the same time both choose to add fuel additives to their tanks, the additive delivery controller 88 may open one or more of the solenoid valves on each of the output manifolds (90 and 92), as discussed in more detail below.

If only one additive is selected by a single customer, one solenoid valve (e.g., 94 or 95) on one output manifold (e.g., 90) is opened, and the corresponding additive pump (e.g., 80 or 82) is operated to draw the additive into and pressurize the corresponding additive line (e.g., 76 or 78). If more than one fuel additive is selected by the same customer, the selected multiplicity of fuel additives may be added to the fuel stream simultaneously by opening both solenoid valves (e.g., 94 and 95) on a given output manifold (e.g., 90) and operating both additive pumps (e.g., 80 and 82) to draw the additives into and pressurize both additive lines (76 and 78). If two customers refueling at the same time both choose to add one or more fuel additives to their tanks, the additive delivery controller 88 may open one or more of the solenoid valves on each output manifold (90 and 92) for delivering the same additive, or potentially different additives, to the customers' fuel tanks at substantially the same time. The additive delivery controller 88 monitors the pressure of the additive(s) in the additive line(s) in use (via electronic signals from pressure transducers 84 and/or 86) and the pressure within the fuel hose(s) in use (via electronic signals from a corresponding pressure transducer 60 and/or 62) to control the amount of additive(s) added to the fuel stream(s).

The simultaneous delivery of one or more additives to one or more fuel streams is possible in the fuel additive delivery system 70 shown in FIG. 2 since there is no shared plumbing (no shared additive lines, pumps, pressure transducers or solenoid valves) between the additive storage tanks. The lack of shared plumbing enables the fuel additive delivery system 70 to avoid cross-contamination between additive products and improves the accuracy of product delivery. In addition, because each additive storage tank/fuel dispenser side combination has a separately controlled solenoid valve, the fuel additive delivery system 70 enables different mix ratios of different additive products to be simultaneously supplied to each fuel hose. It also enables the same additive product to be delivered at potentially different volumes to more than one fuel hose at the same time. Finally, control and accuracy of the fuel additive delivery system 70 is greatly improved over the previous additive delivery system 20, not only by avoiding shared plumbing, but also by arranging the solenoids (94, 95, 96, and 97) at the fuel hoses (52, 54). Because the additive flow control points are as close to the injection sites as possible, and because the response time of the solenoid is short, the delivery accuracy can be significantly increased (e.g., 0.1 mL/delivery vs 0.5 mL/delivery accuracy) compared to the previous additive delivery system 20.

According to one embodiment, the fuel additive delivery system 70 shown in FIG. 2 monitors the pressure in the additive line(s) and in the fuel line(s) and determines the amount of time each solenoid should be opened to deliver the selected mix ratio(s) of additive(s) to each fuel hose. For this reason, the fuel additive delivery system 70 may be otherwise referred to as a time-pressure dosing fuel additive delivery system.

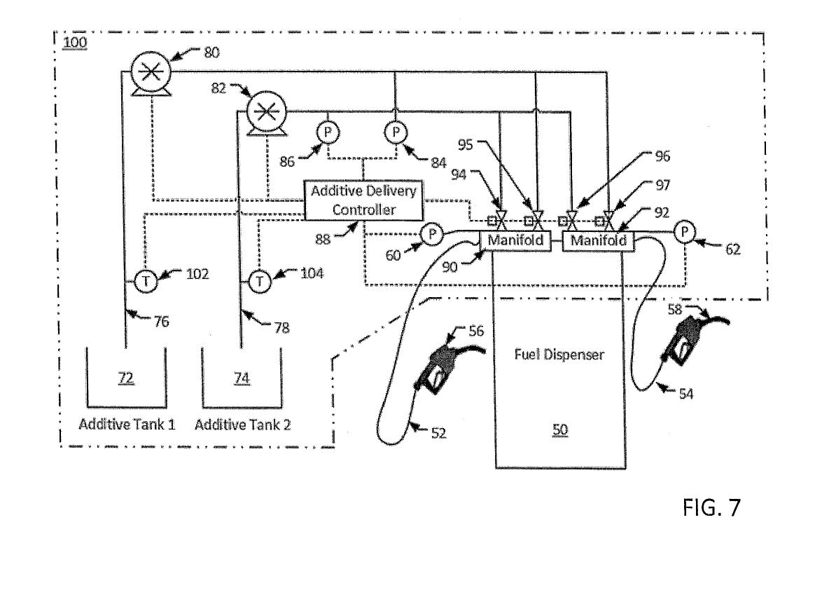

The time-pressure dosing fuel additive delivery system (for a single additive product) generally consists of an additive line (e.g., additive line 76) that is held at a constant pressure via an additive pump (e.g., pump 80), three pressure transducers (e.g., 84, 60 and 62) to measure the additive pressure and the pressure within both fuel hoses (52 and 54), two solenoid valves (e.g., 95 and 97) that connect the pressurized additive line to either fuel hose via an output manifold (90, 92), and the additive delivery controller 88. In some embodiments, the additive delivery system may also include a pressure relief valve or regulator (not shown in FIG. 2) within each additive line to define a pressure limit. In some embodiments, the additive delivery system may also include a temperature sensor within, or coupled to, each additive line for measuring the additive temperature, as shown in the embodiment of FIG. 7 and discussed in more detail below.

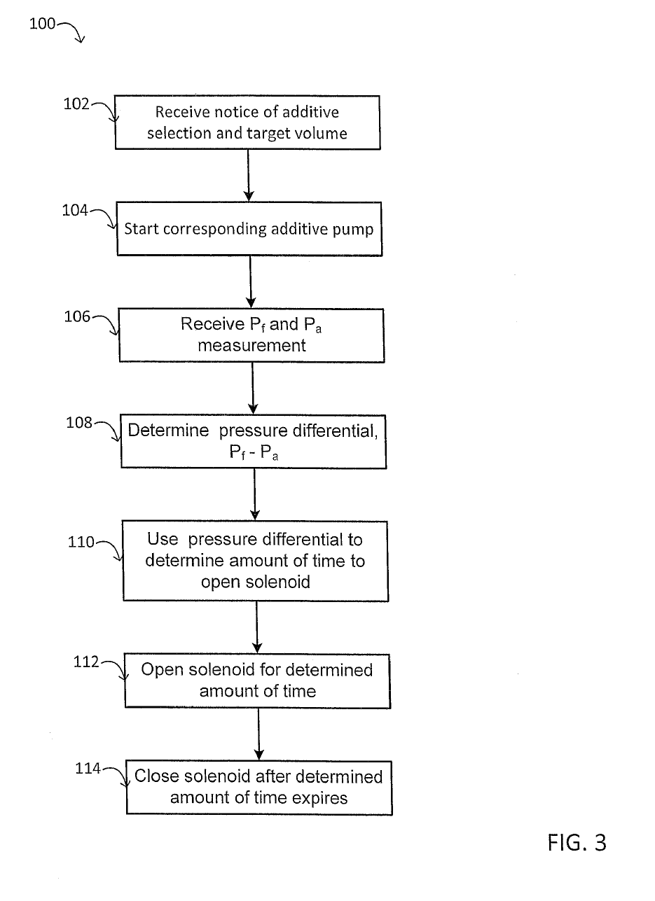

FIG. 3 is a flow chart diagram illustrating one embodiment of a method 100 that may be performed by additive delivery controller 88 for controlling the amount of additive delivered to a customer via a given fuel hose. When an additive is selected by one or more customers, the additive delivery controller 88 receives notice of the customers' additive selection and target volume of additive in step 102, and starts the corresponding additive pump (e.g., 80) in step 104 to draw the additive into and pressurize the additive line (e.g., 76). If a pressure relief valve or regulator is included, pressure builds in the additive line up to the limit defined by the pressure relief valve or regulator.

To deliver the selected additive, the additive delivery controller 88 measures the fuel pressure, P_{f}, delivered to the fuel hoses (via electronic signals received from pressure transducer 60 and/or 62) and the additive pressure, Pₐ (via electronic signals received from pressure transducer 84, for example) in step 106 and calculates the pressure differential (ΔP=P_{f}−Pₐ) for each fuel hose in step 108. In step 110, the additive delivery controller 88 uses the calculated pressure differentials to determine how long each solenoid (e.g., 95 and/or 97) must be held open to deliver the target volume of additive to each fuel hose (52 and/or 54) for each customer requesting such additive. Once the timing has been calculated separately for each fuel hose, the additive delivery controller 88 opens each solenoid valve (e.g., 95 and/or 97) for the determined amount of time in step 112, allowing the amount of additive selected for each fuel hose to flow into the fuel hose(s), and closes the solenoid valve after the determined amount of time expires in step 114. If more than one customer is refueling at the same time, and not all customers select the same additive, the notice of the customers' selection supplied to the additive delivery controller 88 ensures that the additive will only be delivered to the fuel hose(s) and/or customer(s) requesting such additive.

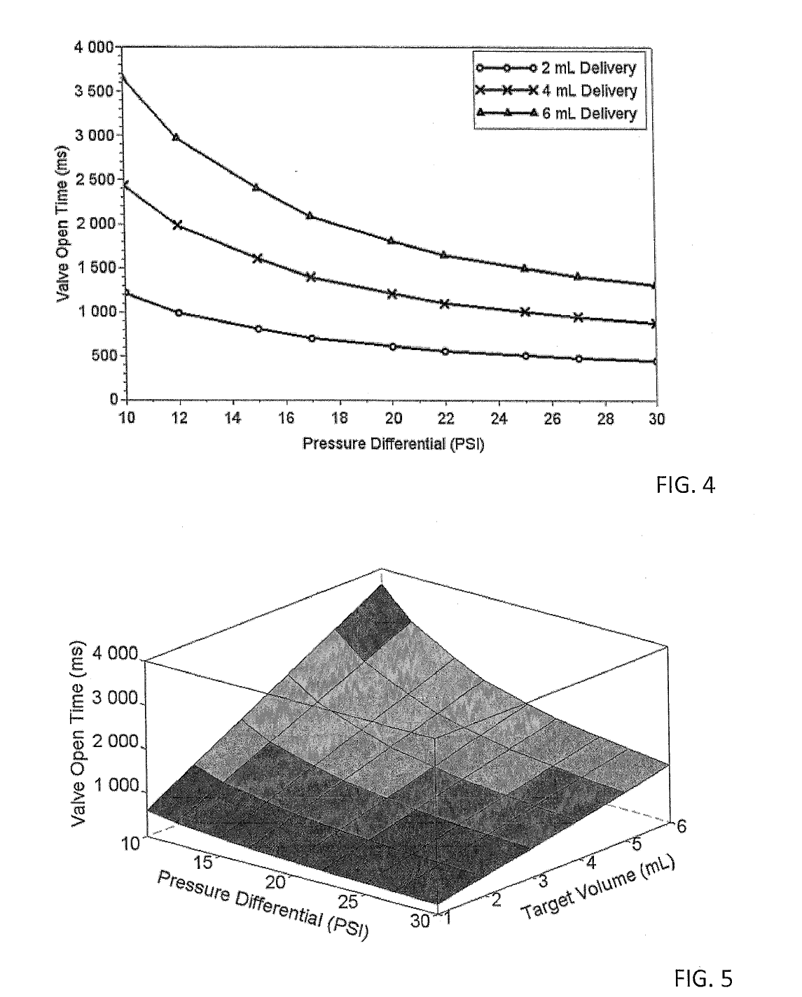

Embodiments of the time pressure dosing fuel additive delivery system described herein may use a variety of different methods for calculating the time each solenoid should be held open to deliver the selected additive or selected mix ratio of additives. FIGS. 4 and 5 are graphs illustrating various manners in which the additive delivery controller 88 may determine the amount of time to open a solenoid valve for delivery of a single additive based on a pressure differential measured between a fuel pressure and an additive pressure (ΔP=P_{f}−Pₐ).

FIG. 4 illustrates three exemplary delivery curves that may be used to specify the amount of time a solenoid valve should be opened (Valve Open Time, ms) based on a pressure differential (Pressure Differential, PSI) measured between a fuel pressure and an additive pressure and a target volume (e.g., 2 mL, 4 mL and 6 mL) of additive product. The delivery curves may be obtained during a calibration phase of the time pressure dosing fuel additive delivery system 70.

According to one embodiment, for example, a pressure relief valve (or regulator) may be adjusted to a first pressure differential (e.g., 10 PSI), the additive delivery controller 88 may be instructed to open a solenoid valve (e.g., 94, 95, 96 or 97) for a specific, short period of time (e.g., 250 ms), and the volume of fluid discharged by the solenoid valve may be measured and recorded. The additive delivery controller 88 may then be instructed to open the solenoid valve for a specific, longer period of time (e.g., 2000 ms), and the volume of fluid discharged by the solenoid valve may again be measured and recorded. This calibration process may be repeated for several different pressure differentials in the expected operating range to produce a table of measured values, such as shown below.

| Pressure | Volume Delivered (mL) | Volume Delivered (mL) |
|---|---|---|
| Differential (PSI) | @ 250 ms | @ 2000 ms |
| 10 | 0.43 | 3.19 |
| 15 | 0.61 | 4.93 |
| 20 | 0.78 | 6.57 |
| 25 | 0.93 | 7.9 |
| 30 | 1.1 | 9.19 |

From these calibration values, a series of linear equations that describe the solenoid open time (t) as a function of target volume (v) can be determined for each pressure differential. Purely for explanatory purposes, examples of such linear equations may be:

@ 10 PSI: t=634.5v−25.37

@ 15 PSI: t=405.5v+9.955

@ 20 PSI: t=302.2v+16.03

@ 25 PSI: t=251.2v+16.38

@ 30 PSI: t=216.5v+10.45

However, since the target volume of delivered additive product is typically fixed while the pressure differential is highly variable, it may be better to use the above equations (or similar equations) to construct a best fit polynomial equation describing the solenoid open time as a function of pressure differential for a number of fixed target volumes (e.g., 2 mL, 4 mL and 6 mL) of additive product. For a fixed target volume of 2 mL, for example:

2 mL @ 10 PSI: t=634.5v−25.37=1244

2 mL @ 15 PSI: t=405.5v+9.955=821

2 mL @ 20 PSI: t=302.2v+16.03=620

2 mL @ 25 PSI: t=251.2v+16.38=519

2 mL @ 30 PSI: t=216.5v+10.45=443

the delivery equation may be: t=−0.1313Δp³+10.149Δp²−275.26Δp+3112.4. This delivery equation is illustrated in the 2 mL Delivery Curve in FIG. 3. The delivery curves for 4 mL and 6 mL of delivered additive product may be generated in a similar manner, and delivery curves for other fixed target volumes of additive product may also be determined.

Once a desired number of delivery curves are generated for desired volumes of additive product, the resulting delivery equations or coefficient values may be stored within memory and used by the additive delivery controller 88 for accurately dispensing desired volume(s) of selected additive(s). In some embodiments, the memory containing the delivery equations or coefficient values may reside within the additive delivery controller 88. Alternatively, additive delivery controller 88 may be coupled for accessing the memory via one or more wired and/or wireless connections. In one example, the delivery equations or coefficient values may be stored within memory located within the fuel dispenser 50, and may be accessed by the additive delivery controller 88 by a wired connection or a wireless connection between fuel dispenser 50 and additive delivery controller 88. In another example, the delivery equations or coefficient values may be stored within memory located at a remote location removed from fuel dispenser 50 and additive delivery controller 88. In such an example, the additive delivery controller 88 may retrieve (or be sent) the delivery equations or coefficient values via a wireless connection as needed, on a periodic basis, or intermittently (e.g., when updates are needed).

The manner by which the additive delivery controller 88 determines the amount of time to open a solenoid for delivery of an additive product is not limited to the method shown in FIG. 3 and described above or the delivery curves shown in FIG. 4. According to another embodiment, FIG. 5 illustrates an alternative method the additive delivery controller 88 may use to specify the amount of time a solenoid should be opened to deliver a target volume of additive. In the embodiment shown in FIG. 5, the calibration data is used to generate a best fit surface, which defines the solenoid open time (Solenoid Open Time, ms) as a function of pressure differential (Pressure Differential, PSI) for a number of fixed target volumes (e.g., 1 mL, 2 mL, 3 mL, 4 mL, 5 mL and 6 mL) of additive product. In the best fit surface shown in FIG. 5, each distinct color or shade represents a different solenoid open time. Like the delivery curves shown in FIG. 4, the best fit surface shown in FIG. 5 may be stored in memory residing within additive delivery controller 88, or coupled to additive delivery controller 88 by one or more wired and/or wireless connections.

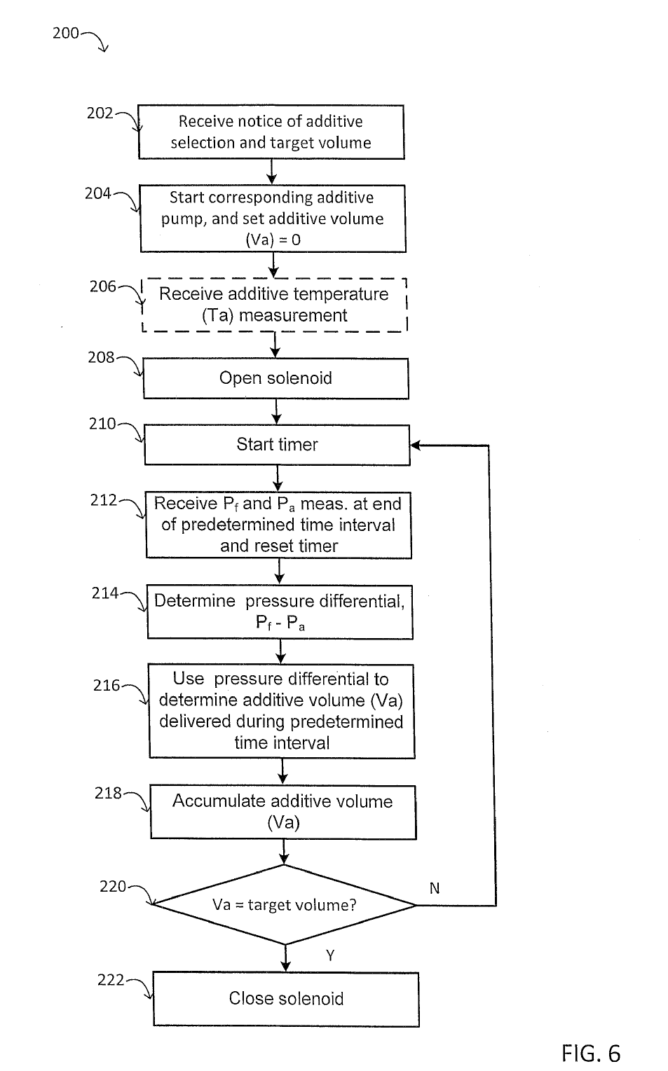

FIG. 6 is a flow chart diagram illustrating another embodiment of a method 200 that may be performed by the additive delivery controller 88 for controlling the amount of additive delivered to a customer via a given fuel hose. In the previously described method 100, a pressure differential (ΔP=P_{f}−Pₐ) was measured, and a solenoid valve for a given additive was opened for a particular amount of time (referred to herein as the “solenoid open time”) corresponding to the measured pressure differential. The solenoid open time was determined using stored calibration data relating pressure differentials at a plurality of different target volumes to solenoid open time. Instead of calculating a solenoid open time before a given solenoid valve is opened, the method 200 shown in FIG. 6 opens the solenoid valve, periodically measures a pressure differential (ΔP=P_{f}−Pₐ) between the fuel and additive pressures over discrete time intervals, determines the additive volume delivered during each discrete time interval, and accumulates the additive volume delivered during each discrete time interval until the accumulated additive volume reaches the target volume. Once the target volume is reached, the solenoid valve is closed by the additive delivery controller 88.

Like the previously described method 100, method 200 may generally begin when the additive delivery controller 88 receives notice of the customers' additive selection and target volume of additive in step 202. In step 204, the additive delivery controller 88 starts the corresponding additive pump (e.g., 80) to draw the additive into and pressurize the additive line (e.g., 76) corresponding to the selected additive. During this step, the additive delivery controller 88 may also set the additive volume (Va) equal to zero. If a pressure relief valve or regulator is included, pressure builds in the additive line up to the limit defined by the pressure relief valve or regulator.

In some embodiments, a temperature sensor (e.g., 102 or 104, FIG. 7) may be included within, or coupled to, the selected additive line for measuring a temperature of the additive (Ta) in optional step 206. As described in more detail below, the additive temperature may be used in some embodiments to compensate for temperature-dependent changes in the additive volume delivered to a customer. Although not strictly necessary, compensating for temperature-dependent changes may improve the accuracy of the additive delivery, and thus, may be preferred in some embodiments. Although illustrated as occurring immediately after the additive pump is started in step 204, it should be understood that the additive temperature could alternatively be measured any time after notice of the customer's additive selection is received in step 202, yet before the measured pressure differential is used to determine the incremental additive volume in step 216.

As shown in FIG. 6, a solenoid valve (e.g., 95 or 97) corresponding to the selected additive line (e.g., 76) and a particular fuel hose (e.g., 52 or 54) is opened in step 208, and an interval timer is started in step 210. The interval timer may be a count-down timer or a count-up timer and may be used to specify a discrete time interval (e.g., 10 ms) for periodically measuring the fuel and additive pressures. At the end of the discrete time interval specified by the interval timer, the additive delivery controller 88 measures the fuel pressure, P_{f}, delivered to the fuel hose(s) (via electronic signal(s) received from pressure transducer 60 and/or 62) and the additive pressure, Pₐ (via electronic signals received from pressure transducer 84, for example) in the selected additive line (e.g., 76) in step 212. In step 214, the additive delivery controller 88 determines a pressure differential (ΔP=P_{f}−Pₐ) between the fuel and additive pressures for each fuel hose delivering the selected additive. Each pressure differential determined in step 214 represents an incremental pressure differential determined for a given fuel hose during a given time interval.

In step 216, the additive delivery controller 88 uses the incremental pressure differential(s) determined in step 214 to determine the additive volume(s) (Va) delivered to the fuel hose(s) during the time interval. There are many different ways in which the pressure differential(s) may be used to determine the additive volume(s). According to one embodiment, a pressure differential (ΔP=P_{f}−Pₐ) determined in step 214 may be used to calculate a mass flow rate (\dot{m}) of the additive product according to:

\dot{m}=C_{d}A\sqrt{2ρΔP}

where \dot{m} is the mass flow rate of the additive product delivered to a fuel hose during a given time interval, C_{d} is the discharge coefficient through the solenoid valve and nozzle, A is the cross-sectional area through the nozzle, ρ is the density of the additive product, and ΔP is the pressure differential calculated in step 214. In order to calculate the mass flow rate (\dot{m}), the discharge coefficient (C_{d}), the cross-sectional area (A), and the density (ρ) of the additive product may be stored within memory residing within or coupled to the additive delivery controller 88.

Once the mass flow rate is calculated for a given time interval, the mass flow rate can be multiplied by the discrete time interval and divided by the density of the additive product to determine the volume (Va) of additive delivered to the fuel hose during the time interval. Each additive volume (Va) determined in step 216 represents an incremental additive volume determined for a given fuel hose during a given time interval.

In step 218, the incremental additive volume (Va) delivered to a given fuel hose during the time interval is accumulated or summed with any incremental additive volumes, which may have been determined during previous time intervals since the solenoid was opened in step 208. If the accumulated additive volume reaches the target volume in step 220, the solenoid is closed in step 222. Otherwise, the integral timer is once again started in step 210 and method steps 212, 214, 216 and 218 are repeated until the accumulated additive volume reaches the target volume in step 220.

In some cases, the iterative method 200 shown in FIG. 6 may provide a more accurate method for delivering a target volume of additive to a fuel hose than even the previously described method 100. Unlike method 100, substantially any target volume can be specified in step 202 of the iterative method, and a corresponding solenoid valve can be opened and can remain open until the accumulated additive volume reaches the specified target volume. In other words, iterative method 200 improves upon method 100 by not relying on or requiring a set of delivery equations or coefficient values to be stored in memory for a predefined, and possibly limited set of target volumes.

As noted above, the discharge coefficient (C_{d}), the cross-sectional area (A), and the density (ρ) of the additive product may be stored within memory and used by the additive delivery controller 88 to calculate the mass flow rate of the additive product delivered to a given fuel hose during a given time interval. In some cases, the discharge coefficient (C_{d}) and the density (ρ) of the additive product may vary with temperature. In order to compensate for such temperature variations, temperature sensors may be used to measure the temperature of the additive product and/or fuel, and a plurality of discharge coefficients (C_{d}) and densities (ρ) may be stored within memory for a plurality of different temperatures. During operation, the additive delivery controller 88 may receive a current temperature measurement from the temperature sensor(s), and may use the current temperature measurement to select an appropriate discharge coefficient (C_{d}) and density (ρ) to be used in the mass flow rate equation.

FIG. 7 is a block diagram of a fuel dispenser 50 comprising, or coupled to, an improved fuel additive dispensing unit 100 according to another embodiment. The fuel dispenser 50 and additive dispensing unit 100 are substantially identical to that described above and shown in FIG. 2 with one main exception. In the embodiment shown in FIG. 7, the time-pressure dosing fuel additive delivery system includes temperature sensors 102 and 104 within, or coupled to, each additive line for measuring the additive temperature. Alternatively, the temperature sensors may be included within the additive storage tanks 72 and 74. As noted above, the additive temperature measured by the temperature sensor(s) 102 and/or 104 may be used by the additive delivery controller 88 to select an appropriate discharge coefficient (C_{d}) and density (ρ) to be used in determining the additive volume delivered during each discrete time interval. In some embodiments, temperature sensors (not shown) may also be included within or coupled to the fuel hoses for measuring a fuel temperature, which may also be used to select an appropriate discharge coefficient (C_{d}) and density (ρ) to be used in determining the incremental additive volume.

In general, the embodiments of time-pressure dosing fuel additive delivery systems shown in FIGS. 2 and 7 increase accuracy of the additive delivery and avoid cross-contamination of additive products by including separate additive lines (e.g., 76 or 78), pumps (e.g., 80 or 82), pressure transducers (e.g., 84 or 86) and solenoid valves (e.g., 94 and 96, or 95 and 97) for each additive storage tank (e.g., 72 or 74). In other words, the additive delivery systems described herein do not share plumbing or meters between the different additive products stored within the additive storage tanks.

Accuracy is further improved in the embodiments shown in FIGS. 2 and 7 by including separate pressure transducers (e.g., 60 or 62) for each fuel hose, and by including an additive delivery controller 88 that uses various methods for controlling the amount of additive delivered to a customer. As shown in FIGS. 3 and 6, for example, the control methods described herein use separate pressure transducers (e.g., 60, 62, 84, 86) to measure the fuel pressure (P_{f}) and the additive pressure (Pₐ) for each fuel hose and each additive product selected by one or more customers. The use of separate pressure transducers for each fuel hose and each additive line enables the additive delivery controller 88 to accurately and independently control the amount of additive (or a mix ratio of additives) supplied to one or more fuel hoses, even when two or more customers utilizing separate fuel hoses request and receive the same additive (or additive mix ratio) or different additives (or additive mix ratios) at substantially the same time.

Although the control methods shown in FIGS. 3 and 6 and described herein both measure fuel pressure (P_{f}) and additive pressure (Pₐ), and use a pressure differential (ΔP=P_{f}−Pₐ) between the fuel and additive pressures to control the amount of additive delivered to a customer, they do so in substantially different manners. In method 100 shown in FIG. 3, the fuel pressure (P_{f}) and the additive pressure (Pₐ) are measured before the solenoid valve is opened, and the pressure differential (ΔP=P_{f}−Pₐ) between the fuel and additive pressures is used to determine an amount of time for which a corresponding solenoid valve should be opened to deliver a target volume of additive. In method 200 shown in FIG. 6, the fuel pressure (P_{f}) and the additive pressure (Pₐ) are measured periodically at discrete time intervals after the solenoid valve is opened and the pressure differential (ΔP=P_{f}−Pₐ) between the fuel and additive pressures is used to monitor the cumulative amount of additive delivered over time, until the cumulative amount of delivered additive reaches the target volume of additive.

Although each of the control methods described herein provides its own advantages, method 200 is able to detect and correct for natural variations in the pressure differential measured between the fuel and additive pressures. In some cases, for example, the fuel pressure at some fuel dispensers may vary depending on the number of customers actively pumping fuel. Since the pressure differential is measured only once in step 106 of method 100, the method shown in FIG. 3 presumes that the pressure differential between the fuel and additive pressures remains constant (or at least varies consistently within and between deliveries). However, this is not generally the case. By periodically measuring the pressure differential over time, method 200 detects and corrects for any pressure differential variations that may occur in the system to further improve accuracy of the additive delivery.

As shown in FIGS. 2 and 7, the additive delivery controller 88 is generally coupled and configured for controlling the additive delivery process. For instance, the additive delivery controller 88 is coupled to each pump (e.g., 80, 82) for selectively activating and deactivating the pumps, and coupled to each solenoid valve (e.g., 94, 95, 96, 97) for selectively opening and closing each solenoid. In addition, the additive delivery controller 88 is coupled to each additive pressure transducer (e.g., 84, 86) for receiving measurements of additive pressures generated within each separate additive line (e.g., 76, 78), and coupled to each fuel pressure transducer (e.g., 60, 62) for receiving measurements of fuel pressures generated within each separate fuel hose (e.g., 52, 54). In some embodiments, the additive delivery controller 88 may be coupled to each temperature sensor (e.g., 102, 104) for receiving measurements of additive temperatures within each separate additive line (e.g., 76, 78).

In general, the additive delivery controller 88 receives measurements from at least one fuel pressure transducer, at least one additive pressure transducer and (optionally) at least one temperature sensor, and performs one of the exemplary methods shown in FIGS. 3 and 6 to control the amount of additive delivered to one or more of the fuel hoses. According to one embodiment, the additive delivery controller 88 may be a microcontroller or other processing device, which is configured to execute program instructions to implement one or more of the methods shown in FIGS. 3 and 6. The program instructions may be stored within the microcontroller, or within memory coupled to the microcontroller by one or more wired and/or wireless connections.

It will be appreciated to those skilled in the art having the benefit of this disclosure that this invention is believed to provide an improved fuel additive delivery system for adding one or more fuel additives into one or more fuel streams at a fuel dispenser. If so requested, the improved fuel additive delivery system allows one or more fuel additives to be added simultaneously to one or more fuel streams at variable mix ratios. Further modifications and alternative embodiments of various aspects of the invention will be apparent to those skilled in the art in view of this description. It is intended, therefore, that the following claims be interpreted to embrace all such modifications and changes and, accordingly, the specification and drawings are to be regarded in an illustrative rather than a restrictive sense.

What is claimed:

1. A system for delivering, and controlling the delivery of, one or more fuel additives to one or more fuel hoses at a fuel dispenser, the system comprising:
a plurality of additive storage tanks, each containing a fuel additive;
a plurality of additive lines, each coupled to a different one of the additive storage tanks for delivering a different one of the fuel additives to the fuel dispenser, wherein for each additive line, the system further comprises:
a pump coupled to the additive line for drawing a corresponding additive into and pressurizing the additive line; and
a pressure transducer coupled for measuring an additive pressure generated within the additive line;
one or more output manifolds arranged at the fuel dispenser, wherein each output manifold is coupled to a different one of the one or more fuel hoses, and wherein each output manifold comprises a plurality of solenoid valves, each coupled to a different additive line; and
an additive delivery controller coupled to each pump, each pressure transducer and each solenoid valve for controlling the delivery of one or more fuel additives to one or more fuel hoses.

2. The system as recited in claim 1, wherein the plurality of additive storage tanks do not share additive lines, pumps, pressure transducers or solenoid valves.

3. The system as recited in claim 2, wherein the additive delivery controller is configured for controlling the delivery of one or more fuel additives to two or more fuel hoses at substantially the same time.

4. The system as recited in claim 1, wherein for each fuel hose, the system further comprises a pressure transducer coupled for measuring a fuel pressure generated within the fuel hose.

5. The system as recited in claim 4, wherein the additive delivery controller is configured for controlling the delivery of a first fuel additive to a first fuel hose by determining a pressure differential between a fuel pressure generated within the first fuel hose and an additive pressure generated within an additive line corresponding to the first fuel additive.

6. The system as recited in claim 5, wherein the additive delivery controller is configured for determining the pressure differential before a solenoid valve, which is coupled to the additive line corresponding to the first fuel additive, is opened to deliver the first fuel additive to the first fuel hose.

7. The system as recited in claim 6, wherein the additive delivery controller is configured for using the pressure differential to determine an amount of time to open the solenoid valve, open the solenoid valve for the determined amount of time, and close the solenoid valve after the determined amount of time expires.

8. The system as recited in claim 5, wherein the additive delivery controller is configured for periodically determining the pressure differential at discrete intervals of time after a solenoid valve, which is coupled to the additive line corresponding to the first fuel additive, is opened to deliver the first fuel additive to the first fuel hose.

9. The system as recited in claim 8, wherein the additive delivery controller is configured for using each periodically determined pressure differential to determine an incremental additive volume delivered during each discrete interval of time, accumulate the incremental additive volumes over the discrete intervals of time, and close the solenoid valve when the accumulated additive volume reaches a target volume.

10. A system for delivering, and controlling the delivery of, one or more fuel additives to one or more fuel hoses at a fuel dispenser, the system comprising:
a plurality of additive storage tanks containing fuel additives;
a separate additive line coupled to each additive storage tank for delivering a fuel additive contained within the additive storage tank to the fuel dispenser;
a separate pump, a separate pressure transducer and a separate solenoid valve coupled to each separate additive line for respectively drawing the fuel additive into and pressurizing the separate additive line, measuring an additive pressure generated within the separate additive line and delivering the fuel additive to a fuel hose; and
an additive delivery controller coupled to each separate pump, each separate pressure transducer and each separate solenoid valve for controlling the delivery of one or more fuel additives to one or more fuel hoses.

11. The system as recited in claim 10, wherein the additive delivery controller is configured for controlling the delivery of one or more fuel additives to two or more fuel hoses at substantially the same time.

12. The system as recited in claim 10, wherein for each fuel hose, the system further comprises:
a separate solenoid valve coupled between the fuel hose and each of the separate additive lines; and
a pressure transducer coupled for measuring a fuel pressure generated within the fuel hose.

13. The system as recited in claim 12, wherein the additive delivery controller is coupled for:
receiving, from a pressure transducer coupled to a first additive line, a measurement of a first additive pressure generated within the first additive line when a first fuel additive is drawn into the first additive line; and
receiving, from a pressure transducer coupled to a first fuel hose, a measurement of a first fuel pressure generated within the first fuel hose.

14. The system as recited in claim 13, wherein the additive delivery controller is configured for executing a set of program instructions for controlling the delivery of the first fuel additive to the first fuel hose based on the first additive pressure measurement and the first fuel pressure measurement.

15. The system as recited in claim 14, wherein when executed by the additive delivery controller, the set of program instructions are configured for determining a pressure differential between the first fuel pressure measurement and the first additive pressure measurement.

16. The system as recited in claim 15, wherein when executed by the additive delivery controller, the set of program instructions are configured for determining the pressure differential before a solenoid valve, which is coupled between the first additive line and the first fuel hose, is opened to the deliver the first fuel additive to the first fuel hose.

17. The system as recited in claim 16, wherein when executed by the additive delivery controller, the set of program instructions are further configured to:
use the pressure differential to determine an amount of time to open the solenoid valve;
open the solenoid valve for the determined amount of time; and
close the solenoid valve after the determined amount of time expires.

18. The system as recited in claim 15, wherein when executed by the additive delivery controller, the set of program instructions are configured for periodically determining the pressure differential at discrete intervals of time after a solenoid valve, which is coupled between the first additive line and the first fuel hose, is opened to the deliver the first fuel additive to the first fuel hose.

19. The system as recited in claim 18, wherein when executed by the additive delivery controller, the set of program instructions are further configured to:
use each periodically determined pressure differential to determine an incremental additive volume delivered during each discrete interval of time;
accumulate the incremental additive volumes over the discrete intervals of time; and
close the solenoid valve when the accumulated additive volume reaches a target volume.

20. The system as recited in claim 19, further comprising a temperature sensor coupled to each separate additive line for measuring a temperature of the fuel additive drawn into and pressurizing the separate additive line.

21. The system as recited in claim 20, wherein the additive delivery controller is coupled for receiving a temperature measurement of the first fuel additive from a first temperature sensor coupled to the first additive line, and wherein when executed by the additive delivery controller, the set of program instructions are further configured to use the temperature measurement, along with each periodically determined pressure differential, to determine the incremental additive volume delivered during each discrete interval of time.
